(19) United States
(12) Patent Application Publication
(10) Pub. No.: US 2015/0262311 A1
(43) Pub. Date: Sep. 17, 2015

(54) SYSTEM AND METHOD FOR NETWORK BASED ACCOUNT DATA MANAGEMENT AND DATA EXCHANGE

(71) Applicant: IOU CONCEPTS INC., Binbrook (CA)

(72) Inventors: Colin Duetta, Binbrook (CA); Michael Salvatori, Burlington (CA); Jeff Teal, Ancaster (CA); Wallace Trenholm, Toronto (CA)

(21) Appl. No.: 14/434,281

(22) PCT Filed: Oct. 10, 2013
(86) PCT No.: PCT/CA2013/000861

§ 371 Date: Apr. 8, 2015

Related U.S. Application Data
(60) Provisional application No. 61/712,998, filed on Oct. 12, 2012.
(60) Provisional application No. 61/810,055, filed on Apr. 9, 2013.

(51) Int. Cl. G06Q 40/00

(52) U.S. Cl. CPC G06Q 40/12

(57) ABSTRACT

A system and method for account data management and exchange is provided. An embodiment includes a client for initiating a transaction. The client includes an account. The client is operable to create a transaction record. Once the transaction record is created, the apparatus can determine a second client to forward the transaction record to. The second is operable to trigger the performance of the selected action to complete and save said record and update corresponding databases, to reject and delete said record or submit said record for further processing.

### RELATED APPLICATIONS

This application claims priority from U.S. patent application 61/712,998, filed Oct. 12, 2012. Priority is claimed to this earlier filed application and the contents of this earlier filed application is incorporated herein, in its entirety, by reference. This application also claims priority from U.S. patent application 61/810,055, filed Apr. 9, 2013. Priority is claimed to this earlier filed application and the contents of this earlier filed application is incorporated herein, in its entirety, by reference.

### FIELD OF INVENTION

The present invention relates generally to data management, and more particularly to a system and method for account management and data exchange.

### BACKGROUND

Various forms of processes exist for accumulation and tracking of values based on account activity. As different process components are adapted for computerized and network based operations using networks based on social networks, for example, the existing processes are becoming inadequate. Accordingly, new processes that address problems specifically associated with computerized and networked relationship based account management systems, including those for the collection, processing, updating and maintaining of transaction data associated with accounts are needed.

### SUMMARY

It is an object to provide a novel system and method for account data management and organization that obviates and mitigates at least one of the above-identified disadvantages of the prior art.

According to an aspect, a transaction server can be provided. The transaction server can comprise:
a processor that can be configured for:
   maintaining an initiating account and a receiving account, categories and networks for associating accounts;
   initiating a transaction record by the initiating account, the transaction record including a category indicator based on the categories, an account relationship indicator based on the networks, a receiving account indicator and a transaction value;
   providing the transaction record to the receiving account based on the receiving account indicator;
   receiving a selection from the receiving account based on the transaction record; and
   determining a final transaction value based on the selection; and
a network interface that can be configured for interfacing with client terminals for accessing the accounts

The selection can comprise an indication of one of: accepting; providing an alternative value; rejecting; and disputing. The selection can be an indication of disputing, and where the selection is a disputing, the determining can comprise:
maintaining a plurality of additional accounts;
selecting a set of panel accounts from the plurality of additional accounts;
providing a dispute notification to the panel accounts; and
receiving a set of inputs from the panel accounts responsive to the notification; and
determining a final transaction value based on the set of inputs.

The transaction record can further include a transaction type selected from at least one of meUp or meDown and the processor can be further configured for:
maintaining, for an initiating account indicated by the initiating account indicator, a first account balance associated with the receiving account; and
when the transaction type is meUp, increasing the first account balance based on the final transaction value; and
when the transaction type is meDown, decreasing the first account balance based on the final transaction value.

The transaction type can be selected from one of youUp or youDown and the processor can be further configured for:
maintaining, for the receiving account, a second account balance associated with the initiating account;
when the transaction type is youUp, increasing the second account balance based on the final transaction value; and
when the transaction type is youDown decreasing the second account balance based on the final transaction value.

The category indicator can be selected from pre-existing category values. The processor can be further configured for:
maintaining a history of final transaction values for each the category values; and
providing an initial transaction value for the transaction record based on the history of final transaction values associated with the category indicator.

The processor can also be configured for:
maintaining a plurality of additional accounts; and
forming a first network by associating, at least some of the additional accounts with an initiating account indicated by the initiating account indicator;
wherein the history of transaction values is further based on transactions involving the first network.

The processor can additionally be configured for:
maintaining a plurality of additional accounts; and
forming a first network by associating, at least some of the additional accounts with an initiating account indicated by the initiating account indicator;
when the selection is an indication of providing an alternative value the determining comprising:
   updating the transaction record with the alternative value;
   transmitting the transaction record to the first client terminal;
   receiving, a second value from the initiating account; and
   determining the final transaction value based on the second selection, the second value being bound by a history of transaction values based on transactions involving the first network.

The network interface can be further configured for:
receiving, at least in part, the networks from third party services.

The network interface can be further configured for transmitting the transaction record, in a finalized form, to third party services for displaying as part of services provided by third party services.

According to another aspect, a method of network based transaction exchange for performance at a server can be provided. The method can comprise:
maintaining a first account and a receiving account, categories and networks for associating accounts;
initiating by the first account, a transaction record, the transaction record including an initiating account indicator a category indicator based on the categories, an account relationship indicator based on the relationships, a receiving account indicator and a transaction value;
providing the transaction record to the receiving account based on the receiving account indicator;
receiving, from the receiving account, a selection based on the transaction record; and
determining a final transaction value based on the selection.

These, together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 shows a block diagram of an embodiment of a system for account data management;

FIG. 2 shows a block diagram of another embodiment of a system for account data management;

FIG. 3 shows a block diagram of another embodiment of a system for account data management, including a profile server and an e-commerce server;

FIG. 4 shows a block diagram of another embodiment of a system for account data management;

FIG. 5 shows a block diagram of another embodiment of a system for account data management;

FIG. 6 shows a flow chart showing a method of account management in accordance with an embodiment;

FIG. 7 shows a diagram of a client in accordance with an embodiment;

FIG. 8(a) shows a diagram of a client in accordance with an embodiment;

FIG. 8(b) shows a diagram of a client in accordance with an embodiment;

FIG. 8(c) shows a block diagram of example database record in accordance with an embodiment;

FIG. 9 shows a diagram of a client in accordance with an embodiment;

FIG. 10 shows a flow chart showing a method of account management and transaction exchange in accordance with an embodiment;

FIG. 11 shows a diagram of a client in accordance with an embodiment;

FIG. 12 shows a diagram of a client in accordance with an embodiment;

FIG. 13 shows a diagram of a client in accordance with an embodiment;

FIG. 14 shows a flow chart showing a method of account management and transaction exchange in accordance with an embodiment;

FIG. 15 shows a diagram of a client in accordance with an embodiment;

FIG. 16 shows a diagram of a client in accordance with an embodiment;

FIG. 17 shows a diagram of a client in accordance with an embodiment;

FIG. 18 shows a block diagram of another embodiment of a system for account data management;

FIG. 19 shows a diagram of a client in accordance with an embodiment;

FIG. 20 shows a diagram of a client in accordance with an embodiment;

FIG. 21 shows a diagram of a client in accordance with an embodiment; and

FIG. 22 shows a diagram of a client in accordance with an embodiment.

### DETAILED DESCRIPTION

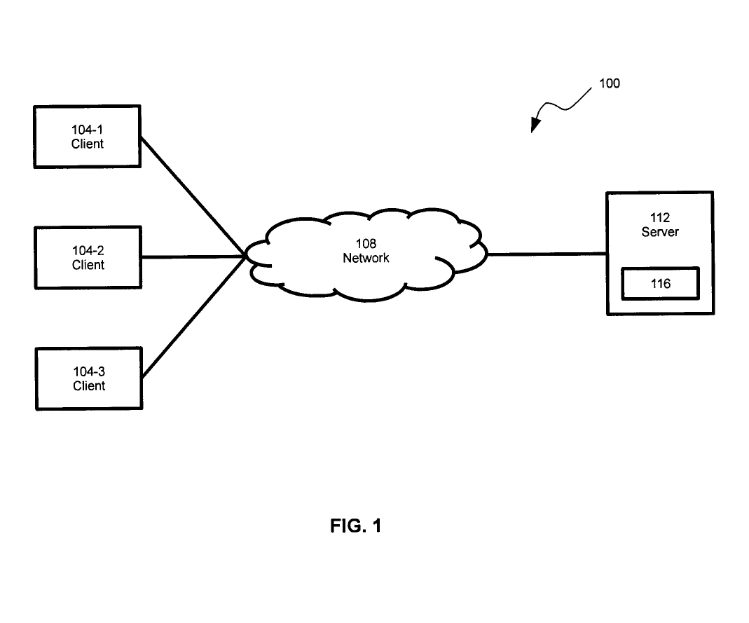

FIG. 1 shows a diagram of a system 100 for maintaining and exchanging transaction-data based on account networks. At least one client terminal (client terminals 104-1, 104-2 and 104-3) is connected, via network 108, to server 112. Collectively, client terminals 104-1, 104-2 and 104-3 are referred to as client terminals 104, and generically as client terminal 104. This nomenclature is used elsewhere herein.

Client terminals 104 can be based on any suitable computing environment, and the type is not particularly limited so long as each client terminal 104 is capable of receiving data from server 112, displaying data in graphical form and transmitting data to server 112. In a present embodiment, client terminals 104 are configured to at least execute a web browser that can interact with the web service hosted by server 112.

Client terminals 104 can be based on any type of client computing environment, such as a desktop computer, a laptop computer, a netbook, a tablet, a smart phone, a PDA, other mobile computing device or any other platform suitable for graphical display that is known in the art. Each client terminal 104 includes at least one processor connected to a non-transitory computer readable storage medium such as a memory. Memory can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In one embodiment, memory includes both a non-volatile memory for persistent storage computer-readable instructions and other data, and a non-volatile memory for short-term storage of such computer-readable instructions and other data during the execution of the computer-readable instructions. Other types of computer readable storage medium external to client terminal 104 are also contemplated, such as secure digital (SD) cards and variants thereof. Other examples of external computer readable storage media include compact discs (CD-ROM, CD-RW) and digital video discs (DVD).

Client terminal 104 can also include one or more input devices connected to at least one processor. Such input devices are configured to receive input and provide data representative of such input to the processor. Input devices can include, for example, a keypad and a pointing device. A pointing device can be implemented as a computer mouse, track ball, track wheel, touchscreen or any suitable combination thereof. In some examples, client terminal 104 can include additional input devices in the form of one or more additional buttons, light sensors, microphones and the like. More generally, any suitable combination of the above-mentioned input devices can be incorporated into client terminal 104.

Client terminal 104 can further include one or more output devices. The output devices of client terminal 104 can include a display. When the pointing device includes a touchscreen, the touchscreen can be integrated with the display. Each client terminal 104 can also include a communications interface connected to the processor. The communications interface allows client terminal 104 to communicate with other computing devices, for example via network 108. The communications interface is therefore selected for compatibility with network 108.

Network 108 can comprise any network capable of linking server 112 with client terminals 104 and can include any suitable combination of wired and/or wireless networks, including but not limited to a Wide Area Network (WAN) such as the Internet, a Local Area Network (LAN), cell phone networks, WiFi networks, WiMax networks and the like.

In general terms, server 112 can comprise any platform capable of processing, transmitting, receiving, and storing data. In a present embodiment, server 112 is a Web server configured for database management and data processing. Server 112 can be based on any desired server-type computing environment including appropriate configurations of one or more central processing units (CPUs) configured to control and interact with non-transitory computer readable media in the form of computer memory or a storage device. Computer memory or storage device can include volatile memory such as Random Access Memory (RAM), and non-volatile memory such as hard disk drives or FLASH drives, or a Redundant Array of Inexpensive Disks (RAID) or cloud-based storage. Server 112 can also includes one or more network interfaces, to connect to network 108 or client terminal 104. Server 112 can also be configured to include input devices such as a keyboard or pointing device or output devices such as a monitor or a display or any of or all of them, to permit local interaction. Other types of hardware configurations for server 112 are contemplated. For example, server 112 can also be implemented as part of a cloud-based computing solution, whereby the functionality of server 112 is implemented as one or more virtual machines executing at a single data center or in a mirrored form across a plurality of data centers. The software aspect of the computing environment of server 112 can also include remote access capabilities in lieu of, or in addition to, any local input devices or local output devices. Any desired or suitable operating system can be used in the computing environment of server 112. The computing environment can be accordingly configured with appropriate operating systems and applications to effect the functionality discussed herein. Those of skill in the art will now recognize that server 112 need not necessarily be implemented as a stand-alone device and can be integrated as part of a multi-purpose server or implemented entirely in software, for example a virtual machine. In a present embodiment, server 112 is connected to a storage device 116, such as a hard-disk drive, solid state drive, or any other type and arrangement of non-volatile storage device.

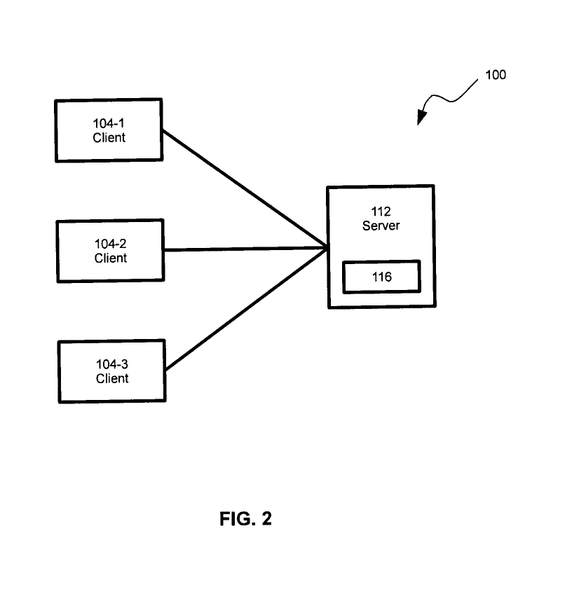

In another embodiment of system 100, as shown in FIG. 2, client terminals 104 may connect directly to server 112.

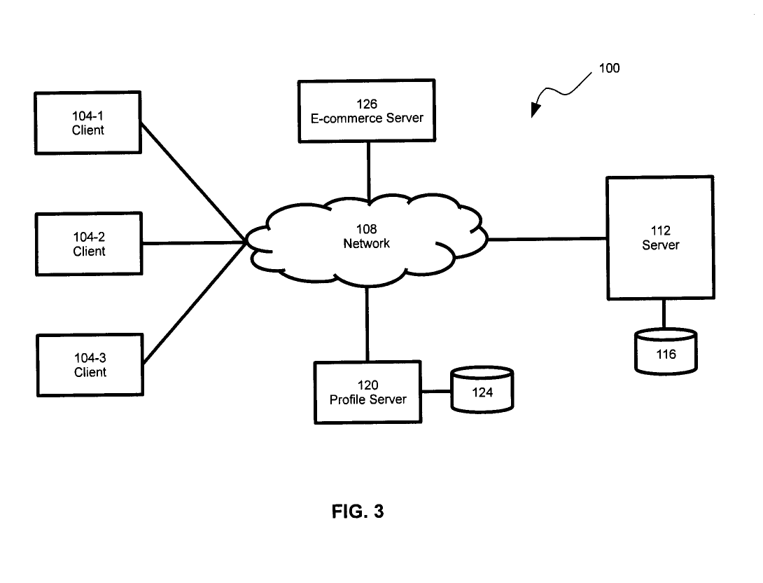

In a further embodiment, as shown in FIG. 3, system 100 can include a profile server 120. In the present embodiment, profile server 120 includes a profile database 124. Broadly speaking, profile database 124 is any database containing information about exchange members. Profile database 124 can also include data obtained from one or more third party services maintained by one or more third party servers, such as Facebook™, Google™, Twitter™ or LinkedIn™, and other networked data sources such web page servers. In one variation, Profile server 120 obtains data from third party services by functioning as an aggregator, accessing the respective service's access points. Alternatively, Profile server 120 can obtain data from third party services and other networked sources by accessing aggregator services that aggregate information from the third party services as well as from other networked information sources. Profile server 120 is typically linked to the third party access points or aggregators, or a combination thereof, through network 108. Other methods of connecting to third party services and aggregators are contemplated such as through proxies and gateways are considered within scope.

It should now be apparent to the reader that in other variations of system 100, profile server 120 can be co-located with Server 112, and have a direct link to server 112. Alternatively, profile server 120 can be connected to server 112 through a network different than network 108 thus allowing the communication between the two servers to bypass network 108. In other variations, profile database 124 can be located on server 112, thus allowing server 112 to perform the functionality of profile server 120.

Continuing with FIG. 3, an E-commerce Server 126 is also shown. E-commerce server 126 is linked to server 112 through network 108, although other variations in connectivity, such as links through a network separate from 108 is contemplated and are within scope. E-commerce server 126 typically hosts an e-commerce site such as an on-line store, and typically has access to inventory and customer databases. Moreover, E-commerce server 126 can generally perform the functions of obtaining customer information, payment information, processing payment and preparing shipment information. E-commerce server 126 may link with one or more other servers or computers, such as a warehouse server, a credit card processing server, and others to perform one or more of its functions.

Variations in the implementation of system 100 will now occur to one of skill in the art, all of which are contemplated as possible implementations of system 100 and are considered within scope. For example, each client 104 can be connected directly to storage device 116, accessing and operating upon the contents of the storage device 116 directly, without an intermediary server 112.

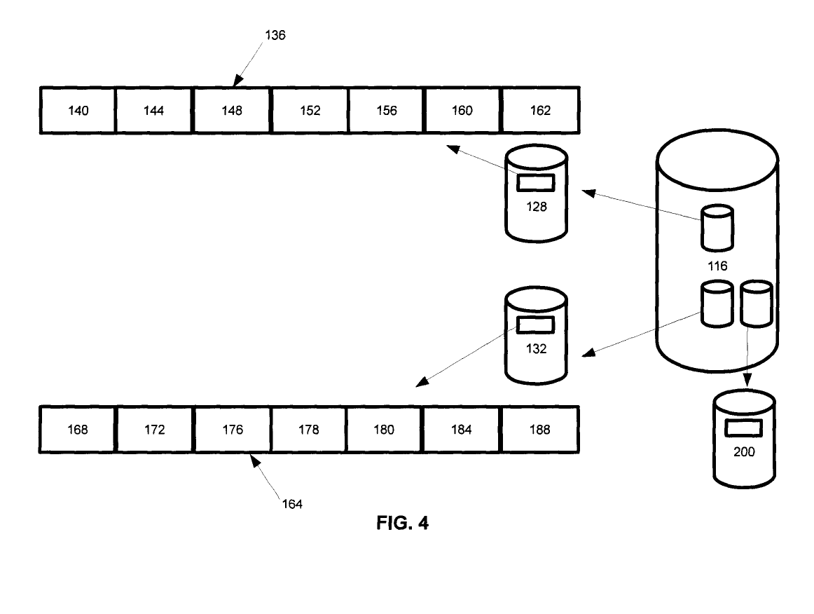

To illustrate the operation of an embodiment of system 100, a simplified representation of the kinds of databases and tables that can be stored at storage device 116 and operated upon by server 112 to perform account management and data exchange is provided as shown in FIG. 4. This example embodiment does not limit system 100 in any manner, but is rather presented purely as an illustrative example to assist with the explanation of system 100.

As shown in FIG. 4, in this example embodiment, storage device 116 contains three separate databases. A transaction database 128 contains all transactions placed using system 100. An account database 132 contains a list of accounts currently used by system 100 for account management and data exchange. A category database 200 includes actions an account holder can perform or has performed which can form the basis of a transaction and its valuation.

FIG. 4 further shows an account record 164 from the account database 132, which is in the form of a row. An account record 164 includes the entry “record ID” 168 for identifying an account record 164. Account record 164 also includes an entry “account ID” 172 and an entry “exchange account” 176. Account ID 172 entry identifies the account to which this record belongs, and can include one or more items such as an account number, account name, and other identifiers. The exchange account 176 entry identifies another account within account database 132 with which the account identified by account ID 172 entry in this record has established a transaction exchange relationship. Account record 164 additionally includes an entry “Relationship” 178 which stores the relationship between the account identified by the account ID entry 172 and the account identified by the exchange account identified in entry 176. Account record 164 further includes an entry “balance” 180 which stores the current account balance obtained on the basis of transactions exchanged between the account identified by the account ID entry 172 and the account identified by the exchange account identified in entry 176. The account record 164 further includes a “transaction history” 184 entry, which stores links to transactions currently pending and already completed. At least a part of the account record data can be obtained from one or more third party services, for example through profile server 120.

FIG. 4 additionally shows a transaction record 136 from the transaction database 128, which is also in the form of a row. The transaction record 136 includes an entry “record ID” 140 which is an entry for identifying a transaction record 136. The transaction record 136 also includes an entry “transaction type” 144, which identifies the current transaction type being processed. Transaction record 136 further includes an entry “category” 148 which represents the selected action category and sub-categories for the transaction record 136, and selected from category database 200. Transaction record 136 additionally includes an entry “me account” 152 and an entry “you account” 156. Me account 152 entry identifies an account stored in account database 132 initiating the transaction, while the you account 148 entry identifies an account stored in account database 132 that is receiving the transaction. Transaction record 136 moreover includes an entry “value” 160 for identifying the current value of the transaction, in terms numerical or qualitative scales such as points. Additionally, transaction record 136 includes a “status” entry 162. The “status” 188 entry stores the current status of the transaction represented by the transaction record 136 such as incomplete, pending, completed, pending, abandoned, or disputed.

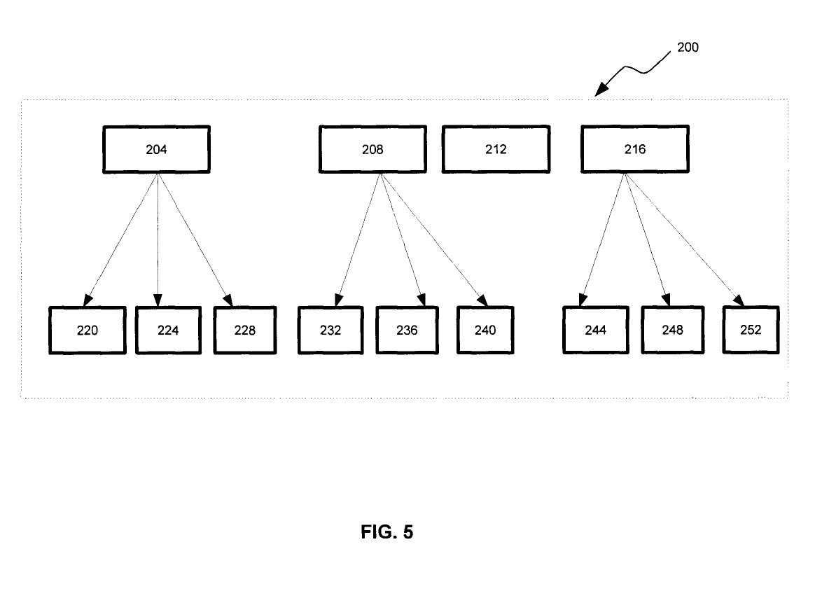

FIG. 5 shows an example category database 200. Categories are the types of actions an account holder can perform or has performed which can form the basis of the transaction and its valuation. A category space includes various categories and subcategories which are used to classify these actions. In this example, the database is represented as multiple trees.

Continuing with FIG. 5, category database 200 includes 4 main categories, each one represented as a parent node: chores 204, gifts 208, intimate encounter 212 and night out 216. As shown in FIG. 5, main category chores 204, includes sub-categories “garbage” 220, “clean house” 224 and “wash car” 228, indicated in FIG. 1 as the children nodes of “Chores” 204. As further indicated by FIG. 5, main category gifts 208 includes subcategories “flowers” 232, “clothing” 236 and “cash” 240, indicated in FIG. 1 as the children nodes of “Gifts” 208. As additionally indicated by FIG. 5, main category “night out” 216 includes subcategories “movies” 244, “dinner” 248 and “drinks” 252, indicated in FIG. 1 as the children nodes of “Gifts” 208.

It should be noted that the category database 200 shown in FIG. 5 is only an illustrative example, and many different category spaces with different main and subcategories are possible. Furthermore, subcategories can have subcategories themselves, and those sub subcategories can have further subcategories, without any limitations on the number of subcategory levels. Moreover, a category space need not be static. For example, as the volume of transactions utilizing a particular category or subcategory increases, that category or subcategory can be broken into additional category or subcategories. Conversely, as the volume of transactions utilizing a particular category or subcategory declines, those categories can be eliminated or merged with other categories or subcategories. For example, if the volume of transactions utilizing subcategory “flowers” 232 increases above a predetermined threshold, additional sub-categories “potted flowers” and “cut flowers” can be added as children of sub-category “flowers” 232. The determination of what categories or subcategories to add can be based on polling accounts in general, or those accounts which have transactions involving subcategory flowers 232 linked in their transaction history entry 184. The determination of what categories or subcategories to add can also be done by system administrators, suggestions by accounts, and through other methods that will now occur to those of skill in the art. For example, in some variations, accounts can manually provide additional categories and subcategories through manual text entry and other means. Accordingly custom transactions could be created for the entered category and or subcategories. The categories can be provided through separate dedicated displays or while entering other transaction details. The created custom transactions can be tracked separately by the system for historical and for setting suggested transaction values. As a further example, if the volume of transactions involving “wash car” 228 and “clean house” 224 fall below a certain threshold, those two categories can be eliminated. All of these variations are within scope.

Transaction database 128, account database 132 and category database 200 can be implemented using a variety of constructs including linked lists, arrays, object oriented containers, relational or flat databases, trees, graphs or recursive structures amongst others. Moreover, although in this embodiment, the data on storage device 116 has been stored in three different databases, in other variations, the data may be stored in fewer or more tables, databases or other structures organized in a different manner. Variations in the implementation of transaction database 128, account database 132, category database 200, as well as the organization of the information on storage device 116 will now occur to one of skill in the art, all of which are contemplated as possible implementations of data storage on device 116 and are considered within scope. For example, transaction record 136 can further include additional entries for sub-category entries as opposed to including the entire category branch in a single entry. Moreover, transaction database 128 and account database 132 can include additional or fewer fields based on the data being stored to implement system 100. Transactions in a transaction database 128 can be viewable globally by all accounts, or have limited visibility such as by the initiator account, receiver account or other combination of accounts that will now occur to a person of skill. The determination of visibility can be performed by various accounts or by the system.

Continuing with the example embodiment, four exemplary transaction types are included. A “MeUp” transaction, if successful, results in an increase in an account balance 180 of the account initiating the transaction. Accordingly, a MeUp transaction results in a reward for the account initiating the transaction for an action performed or to be performed. A “MeDown” transaction, if successful, results in a decrease in an account balance 180 of the account initiating the transaction. Accordingly, a MeDown transaction results in a penalty for the account initiating the transaction for an action performed or to be performed or missed. A “YouUp” transaction, if successful, results in an increase in an account balance 180 of the account receiving the transaction. Accordingly, a YouUp transaction results in a penalty for the account initiating the transaction for an action performed or to be performed or missed. A “YouDown” transaction, if successful, results in a decrease in an account balance 180 of the account receiving the transaction. It should now be apparent to those of skill in the art that in other embodiments other transaction types can be used and these embodiments are within scope. For illustration purposes, in some variations, a MeDown transaction can be redemption of a portion of the account balance. For example, an account A can earn a balance with respect to another account B by performing some actions such as taking out the garbage and buying flowers and entering MeUp transactions as the account initiating a transaction, or a YouUp transaction as the account receiving the transaction. At some later point, account A can choose to redeem a portion of its points earned with respect to account B by, for example, entering a MeDown transaction for a category/subcategory “night out with friends” where account A is the initiating account and account B is the receiving account.

In some variations, changes to the account balance of both parties to a transaction can occur. For example, A “MeUp” transaction, if successful, can result in a decrease in an account balance 180 of the account receiving the transaction as well as in an increase in an account balance 180 of the account initiating the transaction. Similarly, a “MeDown” transaction, if successful, can result in an increase in an account balance 180 of the account receiving the transaction as well as a decrease in an account balance 180 of the account initiating the transaction. Continuing with the example, a “YouUp” transaction, if successful, can result in a decrease in an account balance 180 of the account initiating the transaction as well as an increase in an account balance 180 of the account receiving the transaction. Moreover, a “YouDown” transaction, if successful, can result in an increase in an account balance 180 of the account initiating the transaction in addition to a decrease in an account balance 180 of the account receiving the transaction. The amount of increase and corresponding decrease can be the same or can differ such as where one is a percentage of other. In some variations, some transactions can cause a change to the account balance value of both parties to the transaction, whereas others will cause a change only to one party, either the initiator or the receiver. The account balance values that are to be affected can be specified by the parties or determined automatically by the system.

Continuing with the example embodiment, each transaction can have a status of incomplete, pending, completed, pending, abandoned, or disputed. An incomplete status indicates that the details of the transaction have not been fully entered. A pending status indicates that the transaction details have been fully entered, but the transaction itself has not been fully executed. An abandoned status indicates that the transaction has been abandoned, and thus will not be completed. A completed status indicates that the transaction has been completed, and appropriate point transfer has taken place. A disputed status indicates that the exchanged transaction could not completed by the transacting accounts and thus the transaction is being operated on by peer accounts.

Referring now to Table 1, and continuing with the example embodiment, a portion of a simplified example transaction database is shown organised according to the structure of transaction database 128 as shown in FIG. 4, and stored on storage device 116.

In this example, transaction database 128 of Table 1, the first row shows the column labels. Starting with the second row and below, each row corresponds to a record 136 of the process database 128. Thus, according to Table 1, each record in the example process database 128 includes a record ID 140 entry as identified by the leftmost column labeled “Record ID”, a transaction type 144 entry as identified by the column labeled “Transaction Type”, a category 148 entry, as identified in the column labeled Category”, a me account 152 entry as identified by the column labeled “Me Account”, a you account 156 entry as identified by the column labeled “You Account”, a value 160 entry as identified by the column labeled “Value”, and a status 162 entry as identified by the rightmost column labeled “Status”.

TABLE 1
A Portion of an Example Transaction Database 128

| Re- | Trans- | | | | | |
|---|---|---|---|---|---|---|
| cord | action | Cate- | Me | You | | |
| ID | Type | gory | Account | Account | Value | Status |
| (140) | (144) | (148) | (152) | (156) | (160) | (162) |
| “1” | MeDown | Night | John | Jane | 60 | Completed |
| | | Out/drinks | | | | |
| “2” | YouDown | Night | Jane | John | 40 | Completed |
| | | Out/movies | | | | |
| “3” | MeUp | Gifts/cash | John | Friend | 50 | Completed |
| | | | | One | | |

Continuing with Table 1, the first transaction record 136 of the example transaction database 128 is shown in row two of the table. According to row two, the record ID 140 entry for the first example transaction record 136 is set to “1”, thus identifying the first record as record “1”. The transaction type 144 entry of record “1” is set to “MeDown”. The category of this record is “Night out/drinks”, and is selected from category database 200. Based on the me account 152 entry of record “1”, the account that initiated this transaction was account “John”. Furthermore, according to the you account 156 entry of record “1”, the account receiving this transaction was account “Jane”. Based on the value 160 entry, the value of this transaction was 60, and thus one of account “John”'s account balances 180 entry was deducted, in the manner described further below, 60 points at the completion of this transaction. Based on the status 162 entry, the status of this transaction is completed, meaning that the transaction was successfully completed.

Referring now to the third row of Table 1, the record ID 140 entry for the second example process record 136 is set to “2”. The transaction type 144 entry for record “2” is set to YouDown. The category of this record is “Night out/movies”, and is selected from category database 200. Based on the me account 152 entry of record “2”, the account that initiated this transaction was account “Jane”. Furthermore, according to the you account 156 entry of record “2”, the account receiving this transaction was account “John”. Based on the value 160 entry, the value of this transaction was 50, and thus one of account “John”'s account balances was deducted, in the manner described further below, 40 points at the completion of this transaction. Based on the status 162 entry, the status of this transaction is completed, meaning that the transaction was successfully completed.

Referring next to the fourth row of Table 1, the record ID 140 entry for the second example process record 136 is set to “3”. The transaction type 144 entry for record “3” is set to MeUp. The category of this record is “Gifts/Cash”, and is selected from category database 200. Based on the me account 152 entry of record “3”, the account that initiated this transaction was account “John”. Furthermore, according to the you account 156 entry of record “3”, the account receiving this transaction was account “Friend One”. Based on the value 160 entry, the value of this transaction was 50, and thus one of account “John”'s account balances 180 entry was increased, in the manner described further below, 50 points at the completion of this transaction. Based on the status 162 entry, the status of this transaction is completed, meaning that the transaction was successfully completed.

Referring now to Table 2, a portion is shown of the contents of a simplified example accounts database 132 that is stored on storage device 116, and organized according to the structure of accounts database 132 as shown in FIG. 4. The portion of the example accounts database 132 shown in Table 2 is associated with example transactions database 128 of Table 1, as further explained below. In this example, the first row shows the column labels. Starting with the second row and below, each row corresponds to a record 164 of the accounts database 132. Thus, according to Table 2, each record in the example accounts database 132 includes a record ID 168 entry as identified by the leftmost column labeled “Record ID”, an account ID 172 entry as identified by the column labeled “Account ID” and an exchange account 176 entry as identified by the column labeled “Exchange Account”. Each account record 164 further includes a relationship 178 entry as identified by the column labeled “Relationship”, a Balance 180 entry as identified by the column labeled “Balance” and a transaction history 176 entry as identified by the column labeled “Transaction History”.

TABLE 2
Portion of An Example Account Database 132

| Record | Account | | | | Transaction |
|---|---|---|---|---|---|
| ID | ID | Exchange | Relationship | Balance | History |
| (168) | (172) | Account (176) | (178) | (180) | (184) |
| “A” | “John” | “Jane” | Wife | −100 | “1”, “2” |
| “B” | “John” | “Friend One” | Friend | 50 | “3” |
| “C” | “Jane” | “John” | Husband | 100 | “1”, “2” |

Continuing with Table 2, the first example account record 164 of the example account database 132 is shown in row two of the table. According to row two, the record identifier 168 entry for the first example record 164 is set to “A”, thus identifying the first account record 164 as record “A”. The account ID 172 entry of this record, record “A”, is set to “John”, indicating that this record belongs to account “John”. The exchange account 176 entry for record “A” is “Jane” and indicates that this record is in regards to exchanges between account “John” and account “Jane”. Relationship 178 entry of this record is set to wife indicating that account “Jane” has a wife relationship with account “John”. Balance entry 180 of record “A” is set −100 indicating that the current balance of this record is −100 based on a set of previous transactions exchanged between John and Jane accounts. Transaction entry 184 of this record is set to 1, 2, indicating that transaction records “1” and “2”, described above, form the transaction history for this record.

Continuing with Table 2, the second example account record 164 of the example account database 132 is shown in row three of the table. According to row three, the record identifier 168 entry for the second example record 164 is set to “B”, thus identifying the second account record 164 as record “B”. The account ID 172 entry of this record, record “B” is set to “John”, indicating that this record belongs to account “John”. The exchange account 176 entry for record “B” is “Friend One” and indicates that this record is in regards to exchanges between account “John” and account “Friend One”. Relationship 178 entry of this record is set to friend indicating that account “Friend One” has a friend relationship with account “John”. Balance entry 180 of record “B” is set 50 indicating that the current balance of this record is 50 based on a set of previous transactions exchanged between the “John” and the “Friend One” accounts. Transaction entry 184 of this record is set to “3” indicating that transaction record “3” described above, forms the transaction history for this record.

Continuing with Table 2, the third example account record 164 of the example account database 132 is shown in row four of the table. According to row four, the record identifier 168 entry for the third example record 164 is set to “C”, thus identifying the third account record 164 as record “C”. The account ID 172 entry of this record, record “C” is set to “Jane”, indicating that this record belongs to account “Jane”. The exchange account 176 entry for record “C” is “John” and indicates that this record is in regards to exchanges between account “Jane” and account “John”. Relationship 178 entry of this record is set to husband indicating that account “John” has a husband relationship with account “Jane”. Balance entry 180 of record “C” is set 100 indicating that the current balance of this record is 100 based on a set of previous transactions exchanged between the “Jane” and the “John” accounts. Transaction entry 184 of this record is set to “1” and “2” indicating that transaction records “1” and “2” described above forms the transaction history for this record.

It should be noted that although in this example, the account records 164 “A” and “C” have the same magnitude of balance entry 180 on the basis of the same transaction history 184, in other examples, two account records 164 having the same transaction history 184 can result in different magnitude balances 180. In this example, as shown in Table 2, it is assumed that the transactions that caused John's account balance to change caused an equal and opposite change to Jane's account balance. As a result John and Jane, as indicated in records “A” and “C” share the same account balance but one is the negative of the other.

Furthermore, in this example embodiment, and as shown in Table 2, each account can have multiple account records 164 in the account database 132. The account to which an account record 164 belongs to is identified by account ID 172 entry. For example, in this example embodiment, the account “John” has at least two records, record “A” and record “B”. Moreover, each account record 164 is dedicated to transaction exchange with another account with which the owner account has a transaction exchange relationship. For example, record “A” of account “John” is dedicated to transaction exchanges with account “Jane”, whereas record “B” of account “John” is dedicated to transaction exchanges with account “Friend One”.

At this point it will become apparent to a person of skill in the art that numerous variations for storing the accounts, transactions and categories are possible. For example, all account records that have the same account Id can be collected as a single record within a database to make the management of records belonging to a single account ID more streamlined. Alternatively, completed transactions may only be stored for a time period, and can be discarded after the predetermined time period is over. Alternatively, a subset of completed transaction record fields can be stored as part of an account records, and the completed transaction record discarded after its partial storage in the account record. In some variations a single balance can be maintained with an indicator of which account is positive and which account is negative with respect to that balance.

In some variations, the relationship 178 entry can be determined automatically on the basis of relationships that are, for example obtained from profile database 124 and profile server 120, which can aggregate the information from various web services such as social networks, or directly from such services. In other variations, the relationships can be specified manually. In further variations, the account records can be automatically created. The creation can be on the basis of an Account ID's relationships that are determined from information obtained by profile server 120 from the social network services such as Facebook. In other variations, the account records can be either added manually, or added manually in addition to the automatic records created on the basis of social network service information. These and other variations are within scope.

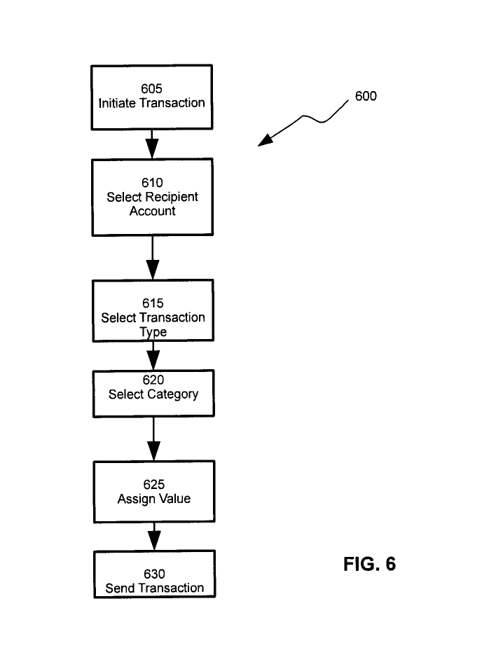

Referring now to FIG. 6, a method of transaction exchange is indicated generally at 600. In order to assist in the explanation of the method, it'll be assumed that method 600 is operated using system 100 as shown in FIG. 3, system 100 further operating on example databases 128 and 132 and 200, as shown in FIGS. 4 and 5, and Tables 1 and 2. Additionally, the following discussion of method 600 leads to further understanding of system 100. However, it is to be understood that system 100, and method 600 can be varied, and need not work exactly as discussed herein in conjunction with each other, and that such variations are within scope.

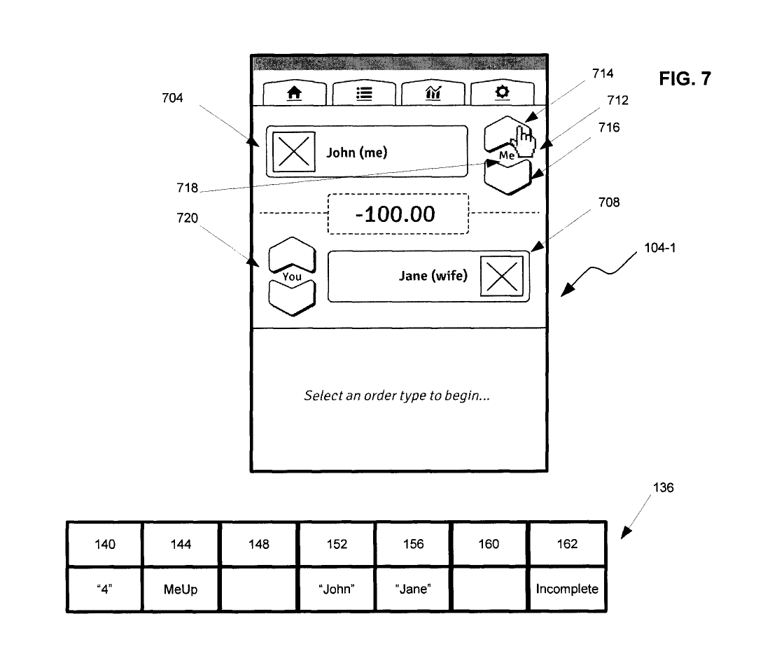

Beginning first at step 605, a transaction is initiated by an account using a client 104-1, and as shown in FIG. 7. In this example, the account ID for the account initiating the transaction is selected through selection box 704 to be “John”. In a variation, selection box 704 can be pre-populated to correspond to the account that is currently logged in at client 104-1. In other variations, account initiating the transaction can be different from the account indicated by the account ID for account initiating the transaction. In some embodiments, the selection box 704 is a text entry box. In other embodiments, the text entry box can be a dropdown list. It will now occur to a person of skill in the art that there are various methods of allowing account selection through a user interface and these variations are within scope. As also shown in FIG. 7, a new transaction record is accordingly created and the record ID 140 is set to “4”. The status entry of the record is updated to “incomplete” and the me account 152 entry is set to “John”. Assuming that a record “4” is validly created, method 600 advances to step 610.

Referring back to FIG. 6, at 610 a recipient account is selected. In this example, the account ID for the account receiving the transaction, the you account, is selected, as shown in FIG. 7, through selection box 708 to be “Jane”. In some embodiments, the selection box 708 is a text entry box. In other embodiments, the text entry box can be a dropdown list. It will now occur to a person of skill in the art that there are various methods of allowing account selection through a user interface and these variations are within scope.

The you account 156 entry of record “4” is also updated as shown in FIG. 7, to reflect the selected account “Jane”. Although in this example, the transaction was initiated prior to selecting a you account, in other variations, the transaction can be created on the basis of the you account selection. For example, the you account, “Jane” in this example, could be selected first, displaying, for example, a history of transactions between John and Jane, and then a new transaction created at that point. The advantage of the variation is that the receiving account can be prepopulated in the transaction record 136, reducing an additional selection and the associated data processing needed.

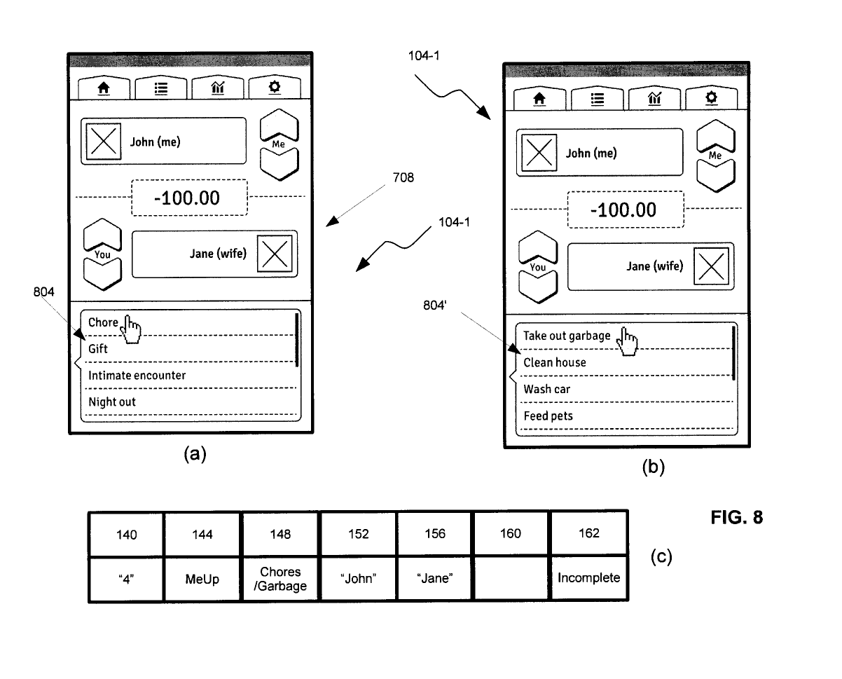

Referring back to FIG. 6, at 615 a transaction type is selected. In this example, and as shown in FIG. 7, the transaction type is selected through selector 712 to be MeUp. As shown, selector 712 consists of two selectable indicators, an up arrow 714 located at the top of selector 712, and a down arrow 716 located at the bottom of selector 712. Selector 712 can further include an account identifier 718, placed in the vicinity of up arrow 714 and down arrow 716. Selector 712 is also placed next to the selection box for the me account to further identify the account with which it is associated. When the up arrow 714 is selected, the transaction type MeUp is selected. When the down arrow 716 is selected, the MeDown transaction type is selected. Selector 720 is used in a similar fashion to select YouUp or YouDown transaction types. Once a selection is made, the selected indicator is highlighted as shown in FIG. 8(a) and FIG. 8(b). In variations, with more than four transaction types, more than two indicator per selector can be used, similarly placed next to the account with which they are associated. Moreover, in yet further variations, the selectable indicators can be distributed in spatial relationships other than top and bottom, such as left and right. These and other variations are within scope. Once the transaction type is selected, transaction type 144 entry of record “4” is updated accordingly, in this case to Meup.

Moving to step 620, a category is selected. Referring now to FIG. 8(a), in this example, selection box 804 displays all available main categories of category space 200 on the basis of the relationship between the me account and the you account. The determination of which account record 164's relationship entry 178 to use is done on the basis of matching the me account “152” and you account entry “156 to account ID entry 172 and exchange account entry 176. In this example, “John and” Jane” are the accounts to match respectively, and thus match account record “A”. Accordingly, the relationship is identified, which in this example is the relationship “wife”. Based on the “wife” relationship, it is determined that all four main categories of category database 200, chores 204, gifts 208, intimate encounter 212 and night out 216 are available, and are thus displayed on client 104-1 as shown in FIG. 8a. In variations, not all main categories may be available for a given relationship. For example, for the relationship “friend”, the category intimate encounter 216 might not be available. These and other variations are within scope. As a further example, in some variations, a main category that is different from the 4 categories shown can be specified using a manual entry such as through a keyboard. Such additional categories can then become available to this and other account holders for use in future custom transactions as appropriate, such as through manual and automatic monitoring.

Once a main category is selected, which in this example will be assumed to be chores 204, the selector box 804 is updated to 804′ to display the subcategories for the selected category chores 204, as shown in FIG. 8(b). In other variations, another selection box may be used to display the subcategories. In yet other variations, a different screen may be utilized. These and other variations are within scope. For example, a subcategory different from the ones displayed can be entered manually. Such additional categories can then become available to this and other account holders for use in future transactions as appropriate, such as through manual and automatic monitoring. In variations, sub-sub categories and further divisions of those can be selected.

Continuing with step 620, a subcategory is selected through selection box 804′, which in this case is garbage implying the chore is taking out the garbage. Record “4” is updated as shown in FIG. 8c to reflect the selected category.

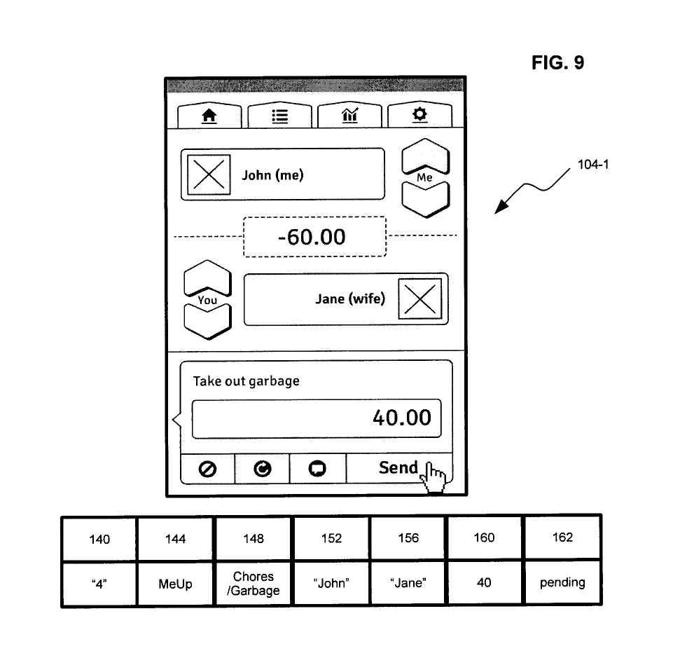

At step 625 a value is assigned to the transaction record “4”. The value can be automatically assigned on the basis of previous transactions having the subcategory. The assignment can be based on the value of last transaction completed for that subcategory, for example. Alternatively, the value can be based on a statistical weighting or averaging of a previous predetermined number of transactions based on the same category/subcategory combination. In other variations, the transactions used for determining the value can have the same relationship, or a set of relationships defined as similar, such as wife, husband and friend. In other variations the automatically set value can be altered through the user interface shown in FIG. 9. In yet other variations, the value may be only set manually through the interface of FIG. 9. Where no previous transactions exist in the system, the value may be only set manually, or a predetermined default value may be assigned. In further variations, the manual value specified can be bounded by statistical determinations based on historical values of other transactions this account has entered into, or historical transactional values of other accounts this account is related to or networked with or historical transactions at large. These statistical determinations can also be based on categories and other classifiers of the transaction. In this example, the value is set to 40. Record “4” is updated accordingly, as also shown in FIG. 9.

At step 630, the transaction is sent. As shown in FIG. 9, the transaction can be sent through a selection made in the user interface. Once the selection is made, the transaction record, or related information can be forwarded to server 112. At this point the transaction record status is also updated to pending. Moreover, record ID “4” can be added to the transaction history of record “A” and record “C” since this transaction involves both accounts.

The interface shown in FIG. 7 through 9, are exemplary only, and in other variations different interfaces might be used. These and other variations are within scope.

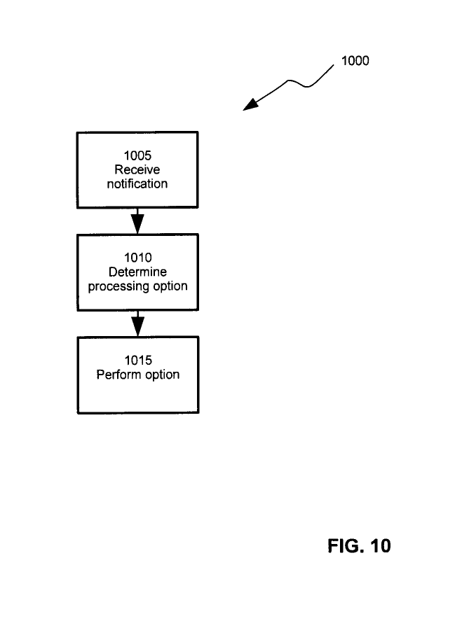

Referring now to FIG. 10, a method of processing a received transaction is indicated generally at 1000. In order to assist in the explanation of the method, it'll be assumed that method 1000 is operated using system 100 as shown in FIG. 3, system 100 further operating on example databases 128 and 132 and 200, as shown in FIGS. 4 and 5, and Tables 1 and 3. Additionally, the following discussion of method 1000 leads to further understanding of system 100. However, it is to be understood that system 100, and method 1000 can be varied, and need not work exactly as discussed herein in conjunction with each other, and that such variations are within scope.

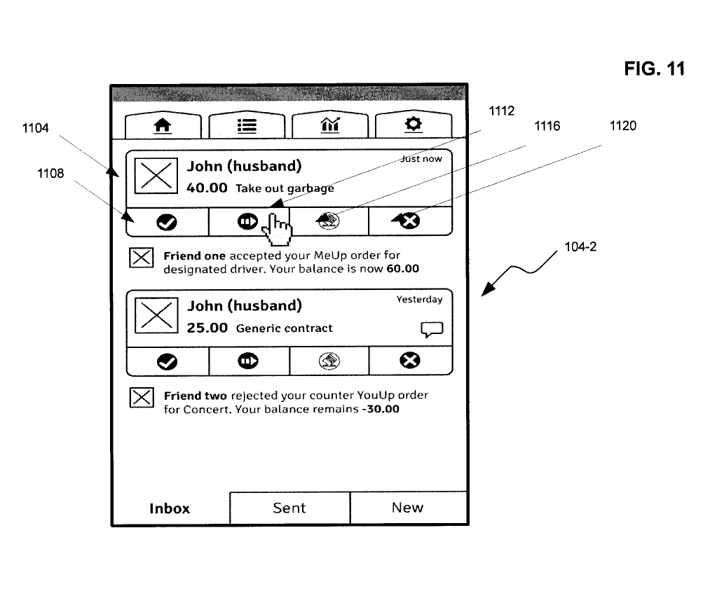

Referring now to FIG. 10, at step 1005, the transaction notification is received. In the present example, transaction record “4”, and/or a notification is sent to client 104-2, at which client account “Jane” is logged in or hosted. In this example, the newly received transaction notification 1104 is shown in FIG. 11 at the top of a list of transactions account “Jane” has been involved in. Furthermore, in this example the list is chronologically organized, but in other variations it may be organized in accordance with other criteria such as transaction status. Moreover, in other variations, client 104-2 notification options, such as LEDs, sound, or vibration, as well as operating system notification facilities such as notification bars may also be used to notify the reception of a new transaction.

Referring back to FIG. 10, an appropriate processing option is selected at step 1010. Referring to FIG. 11, four processing options are shown in association with transaction 1104. Option 1108, when selected, accepts the transaction, completing it at the current value. Once option 1108 is selected, the transaction record “4”'s status entry 162 is updated to complete. Moreover, the balance entry 180 of account record “A” is increased by 40, as determined by the transaction value entry 160, since the transaction type 144 entry of transaction record “4” is MeUp. The determination of which account record 164's balance entry 180 to increase is done on the basis of matching the me account “152” and you account entry “156 to account ID entry 172 and exchange account entry 176. In this example, “John and “Jane” are the accounts to match respectively, and thus match account record “A”.

Continuing with FIG. 11, option 1116 is dispute, which will be described below. Option 1120 is reject, which when selected, deletes this transaction record and notifies the sender of the transaction, in this example, the “John” account. Response, 1112 is counter, which when selected allows the value of the transaction to be altered and sent back to the sender. In this example, it will be assumed that the counter option 1112 is selected. In variations, transactions can be set such that one or more responses are not available. For example, the counter and dispute responses may be disabled, only allowing the acceptance or the rejection of the transaction. In further variations, the manual value specified in a counter can be bounded by statistical determinations based on historical values of other transactions this account has entered into, or historical transactional values of other accounts this account is related to in a network of relationships based on relationship indicators or historical transactions at large. These statistical determinations can also be based on categories and other classifiers of the transaction. In other variation additional responses may be available. These and other variations are within scope.

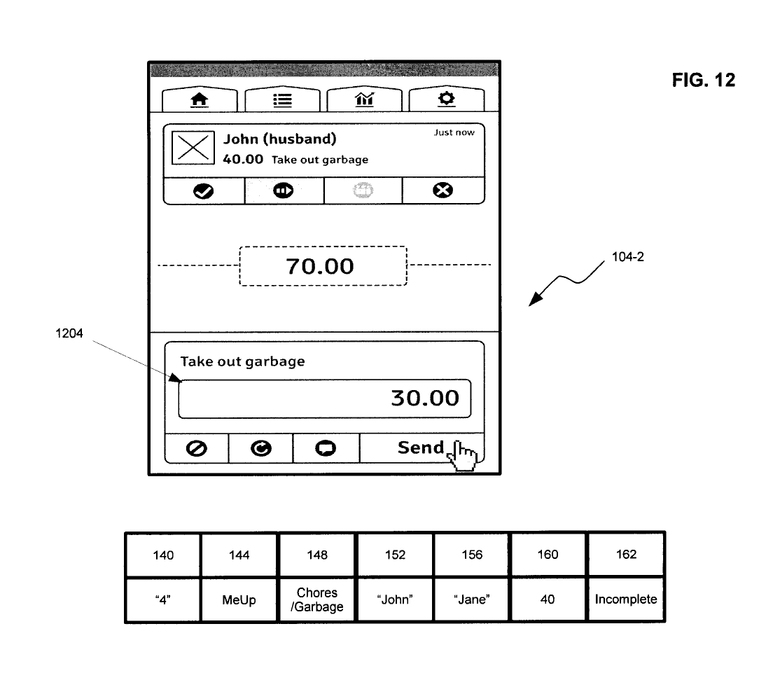

Moving to FIG. 10, at step 1015, the selected option is performed. In this example, referring to FIG. 12, selection box 1204 is used to select a new value for the transaction, and to send the transaction to server 112 to be transmitted to initiating account, in this case “John”. Transaction record “4” is accordingly updated as shown in FIG. 12. Although not shown, transaction requests and counters can include comments explaining the reason for the request and the counter. Also transactions and counters can include reminders, timers and other means of providing deadline indicators for the review and completion of a transaction or a counter.

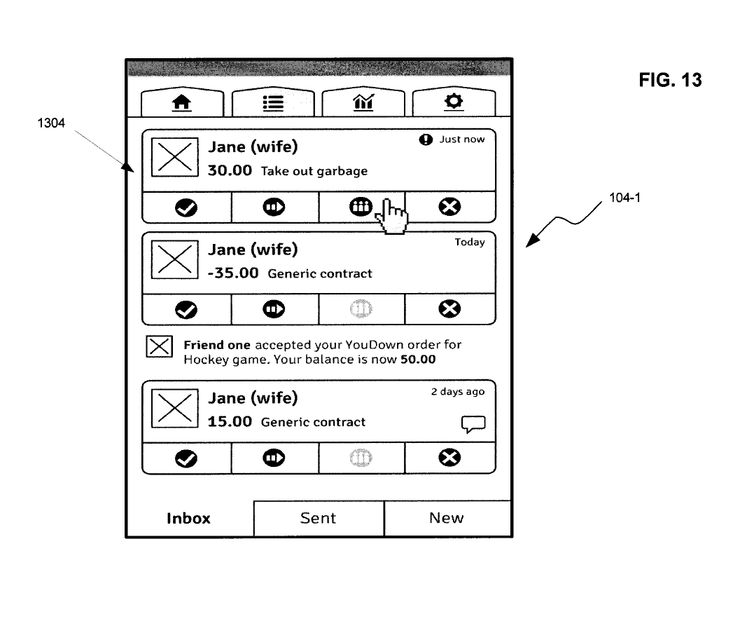

Once the execution of the counter response at step 1015 is completed, method 1000 is once again performed, this time by client 104-1. Accordingly, at step 1005, transaction record “4”, or related information is sent to client 104-1, at which client account “John” is logged in. In this example, the newly received transaction notification 1304 is shown at the top of a list of transactions account “John” has been involved in as shown in FIG. 13. At step 1010 an appropriate processing option is selected. In this example, the option selected is dispute, as shown in FIG. 13. At step 1015, the selected response dispute is executed, which is explained next.

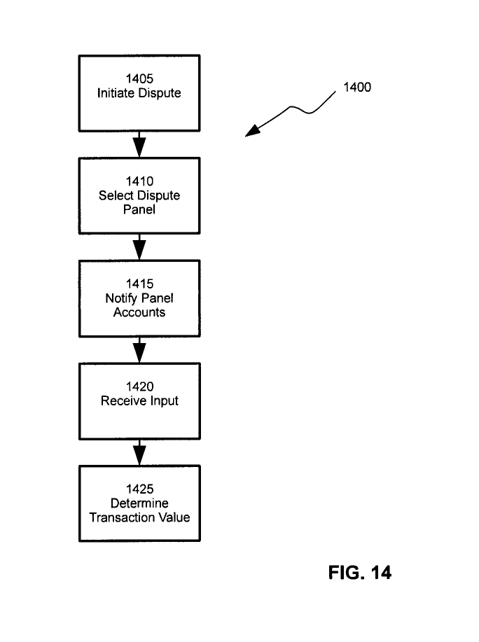

Referring now to FIG. 14, a method of processing a dispute is indicated generally at 1400. In order to assist in the explanation of the method, it'll be assumed that method 1400 is operated using system 100 as shown in FIG. 3, system 100 further operating on example databases 128 and 132 and 200, as shown in FIGS. 4 and 5, and Tables 1 and 3. Additionally, the following discussion of method 1400 leads to further understanding of system 100. However, it is to be understood that system 100, and method 1400 can be varied, and need not work exactly as discussed herein in conjunction with each other, and that such variations are within scope.

Beginning at step 1405, a dispute is initiated. In this example, a dispute is initiated by an account using a client 104-1, and through the selection of the dispute response as explained above. Once a dispute is initiated by one account, the other account involved in the transaction is notified. In a variation, the other account may be presented with the option to cancel the transaction as part of the dispute notification.

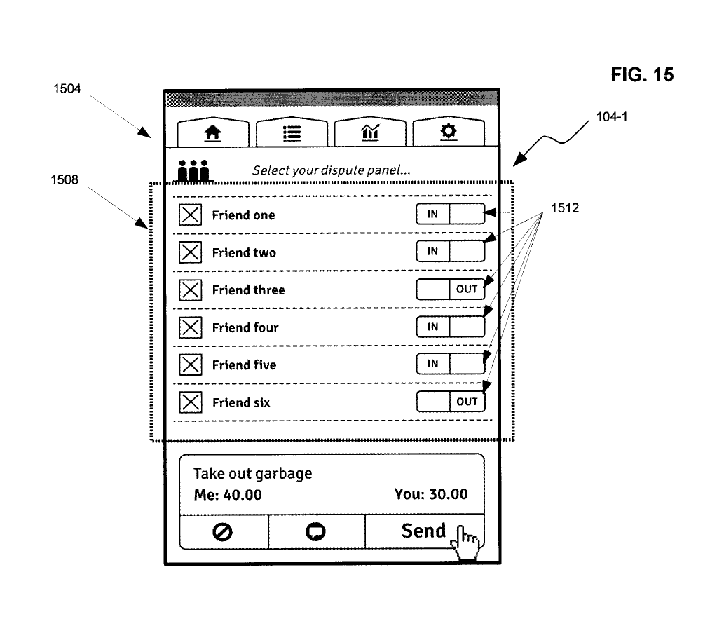

At step 1410 a dispute panel selection is performed. Continuing with the example, and referring to FIG. 15, an example user interface 1504 for panel selection is shown. Selection screen consists of a list 1508 of accounts the account “John” has access to, as well as a selection box 1512 for each account shown in list 1508. At this point it will be apparent to a person of skill in the art that there are various alternative display methods that can be used for displaying and selecting accounts from a list of accessible accounts and all of these variations are within scope. In this example, and as shown in FIG. 15, accounts “Friend One”, Friend Two“, “Friend Four” and Friend Five” have been selected as the panel. In variations the panel can be populated automatically by the system. In further variations, panelists can be system administrator accounts or accounts that are not involved in transaction exchanges. Other variations in panel formation will now occur to those in the skill.

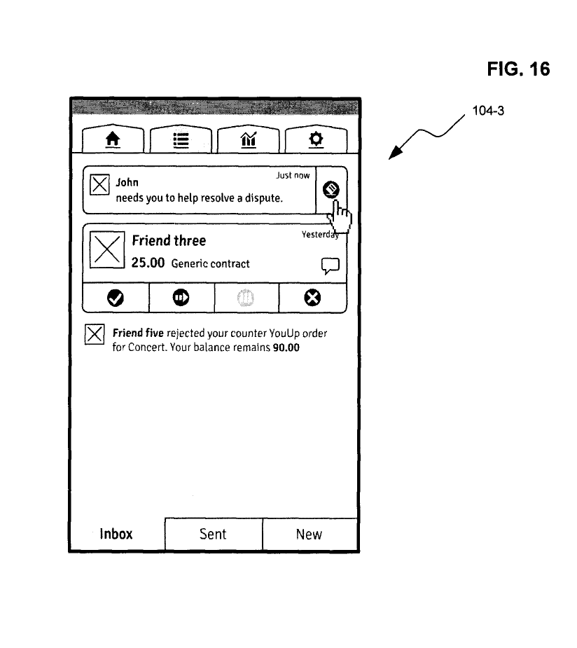

Continuing with method 1400, at step 1415, the accounts forming the panel are notified. Accordingly, data regarding each of the notifications are transmitted to a client 104 at which a panel account is logged in or hosted. In this example, and as shown in FIG. 16, client 104-3, where account “Friend One” is logged in, receives the panel notification. The notification is displayed as part of the transaction history list, but could be provided using various different methods as described above in relation to the transaction notifications. Once the panel notification is selected, method 1400 moves to step 1420.

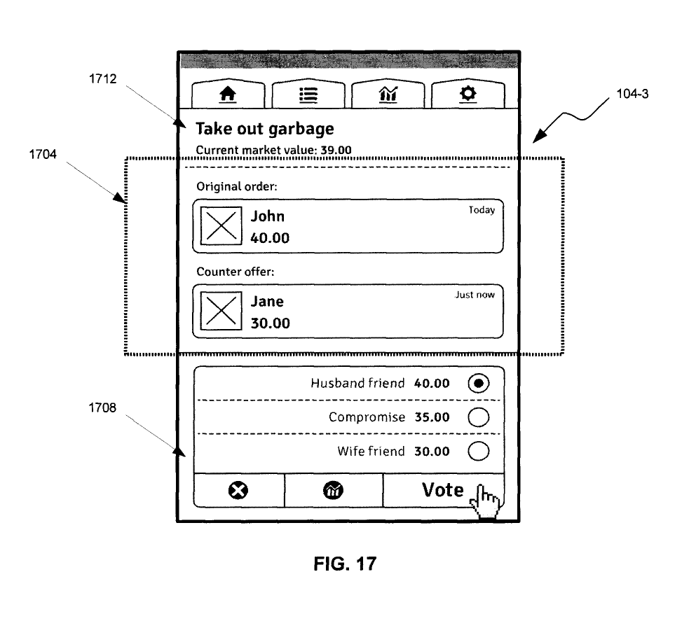

At step 1420, the panelist account input is received. In the present example, a vote selection display is provided. FIG. 17 shows an example display provide on client 104-3 for the account “Friend One”. As shown in FIG. 17, the display includes a list 1704 which is a summary history of the transaction, in this example that the original transaction value was 40, and that the counter transaction value was 30. In addition, options 1708 are provided from which the input for a particular panelist account is selected from. As shown, options 1708 can include the values that are part of the history of the transaction, as well as other values that can be computed by system 100. Furthermore, the current system value 1712 of the transaction can be presented. The current system value can be determined on the basis of previous transactions involving this particular category. For example, the completed value of last 5 transactions involving the category 148 entry of the transaction record 136 can be averaged. Alternatively, the transaction records 136 to be used in calculating the system value 1712 can be selected on the basis of various other transaction or account characteristics such as relationship entry 178 of a related account record 164. Furthermore, computations other than averaging can be used to calculate the current system value 1712. Also, although in this example the current system value 1712 is not part of the options 1708, in other variations it can be. In yet other variations, options 1708 can include a manual value entry choice.

Once an input is received from a predetermined number of panelist accounts, which can be one or more, the final transaction value is determined at step 1425. In this example, the final transaction value is determined on the basis of the panelist inputs. This determination can be based on majority of input values received from the panelist accounts, or an averaging of the values received from panelist accounts. At this point it will be apparent to those of skill in the art that there are various methods of determining a final transaction value on the basis of multiple panel account inputs and all of these are within scope. In this example, it will be assumed that the final value determined by the panelist account input is 40. Accordingly, the value 160 entry of the transaction record “4” set to 40.

Once a final transaction value is chose, the transaction is completed, and the accounts identified by me account entry 152 and you account entry 156 are notified. The transaction record “4”'s status entry 162 is updated to complete. Moreover, the balance entry 180 of account record “A” is increased by 40, as determined by the transaction value entry 160, since the transaction type 144 entry of transaction record “4” is MeUp. It should be noted that in this case the account balance value for Jane has remained the same since it is assumed that the transaction only caused John's account balance to be affected. The determination of which account record 164's balance entry 180 to increase is done on the basis of matching the me account “152” and you account entry 156 to account ID entry 172 and exchange account entry 176. In this example, “John and “Jane” are the accounts to match respectively, and thus match account record “A”. An updated account database 132 is shown in Table 3, and an updated transaction database 128 is shown in Table 4.

TABLE 3
Portion of An Updated Example Account Database 132

| Record | Account | | | | Transaction |
|---|---|---|---|---|---|
| ID | ID | Exchange | Relationship | Balance | History |
| (168) | (172) | Account (176) | (178) | (180) | (184) |
| “A” | “John” | “Jane” | Wife | −60 | “1”, “2”, “4” |
| “B” | “John” | “Friend One” | Friend | 50 | “3” |
| “C” | “Jane” | “John” | Husband | 100 | “1”, “2”, “4” |

TABLE 4
An Updated Example Transaction Database 128

| Re- | Trans- | | | | | |
|---|---|---|---|---|---|---|
| cord | action | Cate- | Me | You | | |
| ID | Type | gory | Account | Account | Value | Status |
| (140) | (144) | (148) | (152) | (156) | (160) | (162) |
| “1” | MeDown | Night | John | Jane | 60 | Completed |
| | | Out/drinks | | | | |
| “2” | YouDown | Night | Jane | John | 40 | Completed |
| | | Out/movies | | | | |
| “3” | MeUp | Gifts/cash | John | Friend | 50 | Completed |
| | | | | One | | |
| “4” | MeUp | Chore/Garbage | John | Jane | 40 | Completed |

In the example embodiments explained so far, the transaction records are stored at server 112, and transmitted to clients 104 for processing and updating. Moreover, clients 104 can also create records. Once created, processed or updated the records are transmitted back to server 112. In other variations, the records and databases may only be stored on server 112, and the clients may act as user interfaces to the server. For example, clients may include HTML 5 based applications that retrieve and update the database information from the server 112, without permanently storing copies of the databases or records. In other examples, clients 104 may maintain copies of part or all of the databases locally at a client 104. In yet other variations, only portions of the database relevant to an account logged in at a particular client 104 may be copied at that client 104. The client 104 storage of the databases and related records could also coincide with the duration of the account log-in at that client. In another variation, clients 104 could perform all the operations without a server, using for example a peer-to-peer network, or communicating via network 108. It will now be apparent to those of skill in the art that there are various ways to structure the storage and maintenance of the databases between the clients and servers of system 100, and all of these variations are within scope.

In yet other variations additional databases, data structures and modules could be used. For example, in one embodiment, a queue may be used to keep a real-time running list of all the current values and counter values for a particular transaction. Accordingly, when a new transaction record 136 is created with a transaction type MeUp, MeDown, YouUp, YouDown, the transaction record, considered a request, is placed in the queue. The queue can be ordered first by price and then by time. As the transaction record is operated on by each account, generating counter values, the values placed by the initiating account and the receiving account may be adjusted until a suitable match is made.

As a further variation, a matcher module can be responsible for matching a particular bid value with an ask value. In this variation, the matcher module would monitor the queue. When an initiating account value and receiving account value are within a predetermined difference, a match would occur, and the transaction would be completed. For example, when a new transaction record 136 is created with a transaction type MeUp, YouDown, MeDown or YouUp then a bid record is created. If the receiving account of the transaction record accepts the cost then this triggers the creation of an ask record at the same price and the bid and ask records are matched, completing the transaction. If the receiving account causes a dispute process to be triggered, or counters with a different value, the methodology continues until there is an appropriate match.

It will now be apparent to those of skill in the art that there are various ways to architect the storage and maintenance of data for account management and transaction exchange as well as various ways to organize data processing modules of system 100, and all of these variations are within scope. For example, in variations, cumulative totals for personal and net balances across all relationships can be maintained. In some variations, a net balance for a given relationship can be determined and indicated on a display. For example if an account A has an account balance of 50 with respect to an account B, and an account B has an account balance of 20 with respect to account A, the net balance can be 30 in favor of account A. The net balance can be indicated on a display by an arrow. The arrow can tilt towards an indicator of account A when the net balance is in favor of A, and away from an indicator of account A when it favors Account B. Other methods of indicating a net balance will now occur to a person of skill and are within scope. In further variations, the determined net balance between accounts can be normalized. The normalization can be with respect to the values in the specific relationship or with respect to a network of relationships. The normalization can allow indicated net balances from different relationships to be in a similar range and thus to be comparable. For example, in this example relationship of account A and B, the net balance can be expressed as a percentage of the highest account balance 50. Thus, the net balance for the example would be expressed as 30/50 or 60%.

In other variations, cumulative totals by transaction type such as MeUp, YouUp can be maintained. Net balance or cumulative totals can be used during the dispute process to resolve disputes. Transaction histories for all transactions can be maintained. Transaction results, individually, or in aggregate can also be exported to other systems, such as other third party services to be provided as part of the third party service. Accordingly, a transaction or multiple transactions can be displayed as part of the timelines provided by third party services for a given account. The transactions can be exported as they are completed or at any other point as appropriate.

In a further variation, account balances can be redeemed, for example, for cash or wares, or products and services offered by ecommerce servers such as server 126. In this variation, products or services offered by server 126 can be acquired using account balances from one or more account records 164 associated with an account.

In a further embodiment, transaction records 136 can be created by specifying multiple accounts for you account entry 156. In this case, the incomplete transactions are made available to all accounts specified in you entry 156. In one embodiment, all accounts that receive the transaction can complete a transaction with the account initiating the transaction. In this embodiment, a new transaction record 136 would be created for each account that chooses to accept or counter or dispute the transaction. In another variation, only one transaction can be completed. In this embodiment, the receiving accounts would be able to accept or counter the transaction value specified in the value 180 entry of the transaction record 136. If multiple acceptances or counters are received, a method of selecting from these multiple accounts could be used to select the countering or accepting account with which to complete the transaction. For example account “John” could create a YouUp transaction for the category chores/garbage selecting, as the you account, all accounts with which it has a child relationship as specified in relationship 178 entry of its account records 164. The selected you accounts can then accept and counter. In this example, the account that has countered with the lowest value could be selected to complete the transaction. In this example, the transaction in effect creates a bidding for earning points to take out the trash. The child account agreeing to do it for the least amount of points gets to complete the transaction.

In another variation, the created transaction can be completed a limited number of times, namely, a predetermined number of transaction records 136 can be created and completed as a result of the initial transaction record 136. In this variation, the method of selecting from multiple accounts can be engaged once the number of recipient accounts attempting to complete the transaction exceeds the predetermined number of transaction records 136 that can be created. In yet another variation, a transaction record 136 can be set to expire if they are not acted upon or completed within a specific time frame.

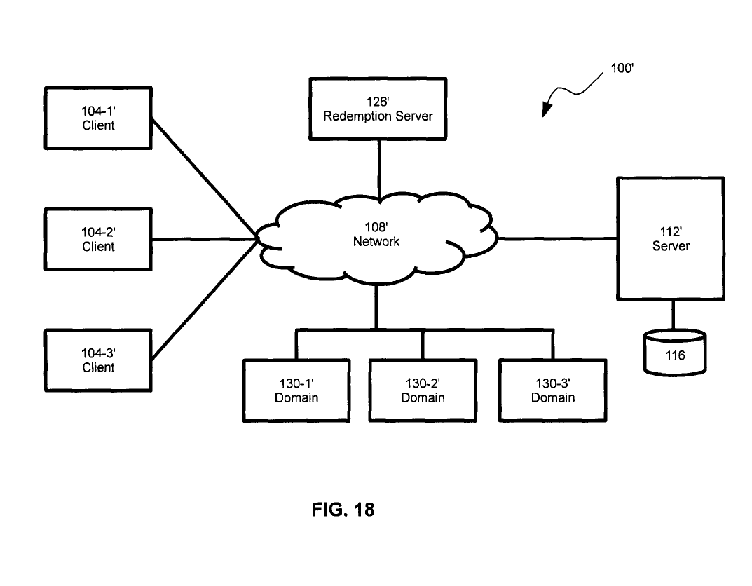

In another embodiment system 100 and methods 600, 1000 and 1400 can be applied to different account domains. For example, as illustrated in FIG. 18 system 100′ consists of the same elements as system 100, denoted by the same number appended with a System 100′ includes additional elements, domains 130-1′, 130-2′ and 130-3′. Collectively, domains 130-1′, 130-2′ and 130-3′ are referred to as domains 130′, and generically as domain 130′. This nomenclature is used elsewhere herein. Each domain 130′ comprises a collection of accounts. For example, domain 130-1′ can comprise accounts of one school's students, “Student 1”, “Student 2”, and “Student 3”, domain 130-2 can comprise the accounts of another school's students “Student 1”, “Student 2”, and “Student 3”, and domain 130-3 can comprise school board accounts “Foodbank” and “Homeless shelter”. In one embodiment, each domain 130 is a separate server managing databases associated with system 100′ and the accounts within that domain. Moreover, additional databases may be maintained at server 112 to enable the performance of methods 600, 1000 and 1040 for transactions that involve accounts between domains. In a variation, the domains and their databases are maintained at server 112.

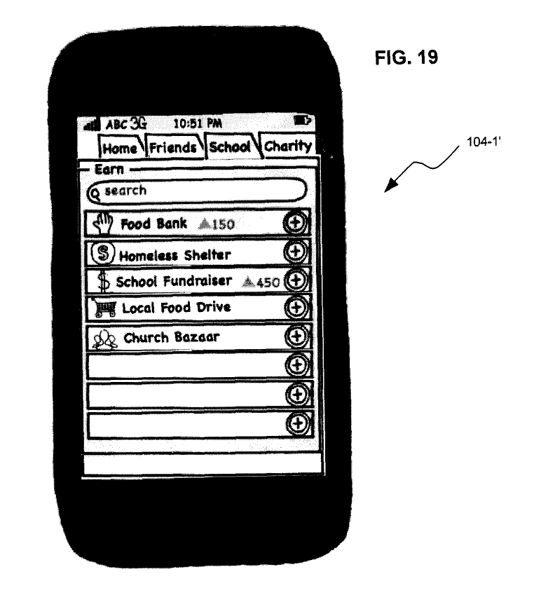

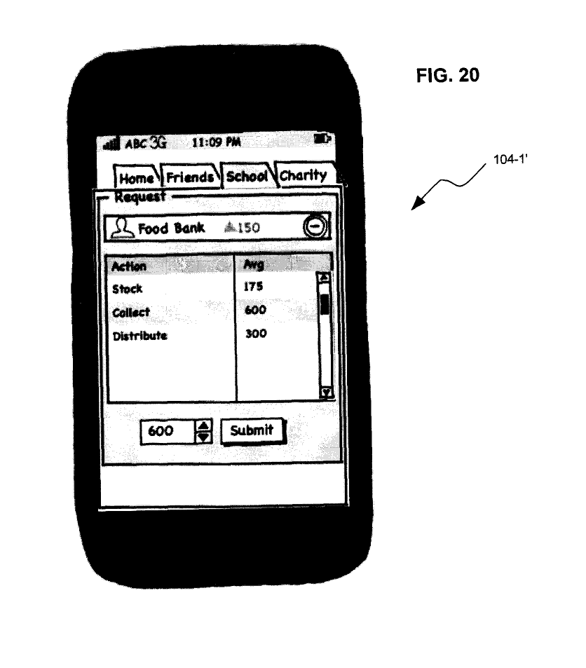

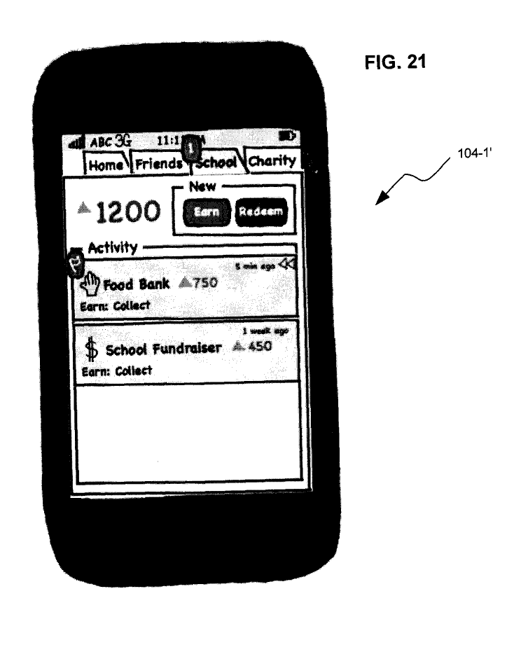

In a further embodiment, system 100′ can be used, for example, to implement a volunteer system for school boards. In this example, the accounts maintained by school board 103-3′ domain may make available transaction records 136 where the you account entry 156 is specified to be all student accounts in all domains. As shown in FIG. 19, an example student account logged in at client 104-1′ would receive transaction notifications at client 104-1′ from multiple accounts from the school board domain 130-3′, including “Food Bank” and Homeless Shelter“. Once a specific account domain is selected, which in this example is assumed to be the “Food Bank”, available transactions from the “Food Bank” account can be provided as shown in FIG. 20. Once a transaction is chosen and accepted, in this case collecting food for 600 points, the student account balance can be increased to reflect the new transaction as shown in FIG. 21. In a variation, the balance updates can be performed after a certain time elapses so that the performance of the promised action can be confirmed. In yet another variation, the points earned can be redeemed using the redemption server 126′.

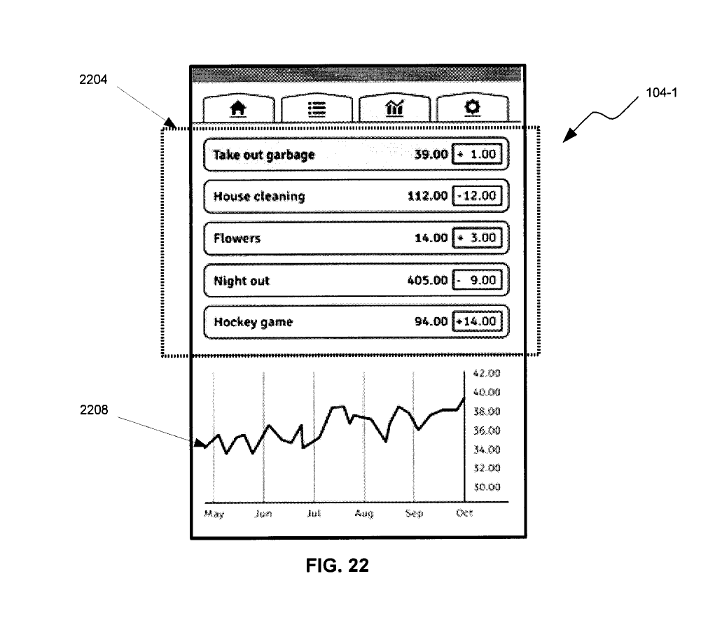

In a further variation, system 100 and system 100′ can maintain historical values representative of transactions completed or transactions pending. For example, the historical values maintained may be daily, and the daily values may be those that are the last completed for each day. In another variation, daily values may be maintained for each category or sub-category of each transaction completed. As an example, referring to in FIG. 22, a list 2204 of latest completed transaction values for selected categories may be maintained and provided to an account. Upon selection of one of the categories, an object 2208 may be provided that indicates the daily historical values of completed transactions for that category.

In another embodiment, the historical values or volumes or both may be maintained on the basis of account relationships as defined in relationship entry 178 of an account record 164. Accordingly, historical values for certain categories may be maintained for example, for all transactions involving parent and child relationships. In this embodiment, when a new transaction is created, the accounts involved in the transaction can be informed of the historical or latest values and volumes for the category of the transaction for that relationship. For example, when a transaction is created for the garbage 220 subcategory, the transaction being between a parent and a child, historical volumes and values for only those transactions which include the parent/child relationship involving the garbage subcategory 220. In another example, historical values accumulated and presented may be on the basis of the accounts engaged in the transaction. In this example, the accounts could be presented how they have valued this category in the past, and how the other party has valued this category of transaction in the past. In other variations, one set of historical data may be maintained, and other subsets may be generated on the basis of specified criteria such as categories, relationships and others discussed above.

It will now be apparent to those of skill in the art that other historical measures of transaction values and volumes, pending or completed, are possible and can be stored as part of the operation of system 100 and 100′. These measures may include, for example value ranges for completed transactions, and value ranges for pending transactions. These and other measures are within scope. Furthermore, historical measures may be accumulated and presented on the basis of criteria other than relationship and account, such as the time or season of the transaction, domain 130′ of the transaction or a combination of these and other criteria that will now occur to a person of skill in the art.

The above-described embodiments are intended to be examples and alterations and modifications may be effected thereto, by those of skill in the art, without departing from the scope which is defined solely by the claims appended hereto. For example, methods, systems and embodiments discussed can be varied and combined, in full or in part.

We claim:

1. A transaction server comprising:
a processor configured for:
maintaining an initiating account and a receiving account, categories and networks for associating accounts;
initiating a transaction record by said initiating account, said transaction record including a category indicator based on said categories, an account relationship indicator based on said networks, a receiving account indicator and a transaction value;
providing said transaction record to said receiving account based on said receiving account indicator;
receiving a selection from said receiving account based on said transaction record; and
determining a final transaction value based on said selection; and
a network interface configured for interfacing with client terminals for accessing said accounts

2. The server of claim 1 wherein said selection comprises an indication of one of: accepting; providing an alternative value; rejecting; and disputing.

3. The server of claim 2 wherein said selection is an indication of disputing, said determining comprising:
maintaining a plurality of additional accounts;
selecting a set of panel accounts from said plurality of additional accounts;
providing a dispute notification to said panel accounts; and
receiving a set of inputs from said panel accounts responsive to said notification; and
determining a final transaction value based on said set of inputs.

4. The server of claim 1 wherein said transaction record further includes a transaction type selected from at least one of meUp or meDown, said processor further configured for:
maintaining, for an initiating account indicated by said initiating account indicator, a first account balance associated with said receiving account; and
when said transaction type is meUp, increasing said first account balance based on said final transaction value; and
when said transaction type is meDown, decreasing said first account balance based on said final transaction value.

5. The server of claim 4 wherein said transaction type is selected from one of youUp or youDown, said processor further configured for:
maintaining, for said receiving account, a second account balance associated with said initiating account;
when said transaction type is youUp, increasing said second account balance based on said final transaction value; and
when said transaction type is youDown decreasing said second account balance based on said final transaction value.

6. The server of claim 1 wherein said category indicator is selected from pre-existing category values.

7. The server of claim 6, said processor further configured for:
maintaining a history of final transaction values for each said category values; and
providing an initial transaction value for said transaction record based on said history of final transaction values associated with said category indicator.

8. The server of claim 7, said processor further configured for:
maintaining a plurality of additional accounts; and
forming a first network by associating, at least some of the additional accounts with an initiating account indicated by said initiating account indicator;
wherein said history of transaction values is further based on transactions involving said first network.

9. The server of claim 2, said processor further configured for:
maintaining a plurality of additional accounts; and
forming a first network by associating, at least some of the additional accounts with an initiating account indicated by said initiating account indicator;
when said selection is an indication of providing an alternative value said determining comprising:
updating said transaction record with said alternative value;
transmitting said transaction record to said first client terminal;
receiving, a second value from said initiating account; and
determining said final transaction value based on said second selection, said second value being bound by a history of transaction values based on transactions involving said first network.

10. The server of claim 1, said network interface further configured for:
receiving, at least in part, said networks from third party services.

11. The server of claim 10 wherein said network interface is further configured for transmitting said transaction record, in a finalized form, to third party services for displaying as part of services provided by third party services.

12. A method of network based transaction exchange for performance at a server comprising:
maintaining a first account and a receiving account, categories and networks for associating accounts;
initiating by said first account, a transaction record, said transaction record including an initiating account indicator a category indicator based on said categories, an account relationship indicator based on said relationships, a receiving account indicator and a transaction value;
providing said transaction record to said receiving account based on said receiving account indicator;
receiving, from said receiving account, a selection based on said transaction record; and
determining a final transaction value based on said selection.

13. The method of claim 12 wherein said selection comprises an indication of one of: accepting; providing an alternative value; rejecting; and disputing.

14. The method of claim 13 wherein said selection is an indication of disputing, said determining comprising:
maintaining a plurality of additional accounts;
selecting a set of panel accounts from said plurality of additional accounts;
providing a dispute notification to said panel accounts;
receiving a set of inputs from said set of panel accounts responsive to said notification; and
determining a final transaction value based on said set of inputs.

15. The method of claim 12 wherein said transaction record further includes a transaction type selected from at least one of meUp or meDown, said method further comprising:
maintaining, for an initiating account indicated by said initiating account indicator, a first account balance associated with said receiving account; and
when said transaction type is meUp, increasing said first account balance based on said final transaction value; and
when said transaction type is meDown, decreasing said first account balance based on said final transaction value.

16. The method of claim 15 wherein said transaction type is selected from one of youUp or youDown, said method further comprising:
maintaining, for said receiving account, a second account balance associated with said initiating account;
when said transaction type is youUp, increasing said second account balance based on said final transaction value; and
when said transaction type is youDown decreasing said second account balance based on said final transaction value.

17. The method of claim 12 wherein said category indicator is selected from pre-existing category values.

18. The method of claim 17, further comprising:
maintaining a history of final transaction values for each said category values; and
providing an initial transaction value for said transaction record based on said history of final transaction values associated with said category indicator.

19. The method of claim 18, further comprising:
maintaining a plurality of additional accounts; and
forming a first network by associating, at least some of the additional accounts with an initiating account indicated by said initiating account indicator;
wherein said history of transaction values is further based on transactions involving said first network.

20. The method of claim 13, further comprising:
maintaining a plurality of additional accounts; and
forming a first network by associating, at least some of the additional accounts with an initiating account indicated by said initiating account indicator;
when said selection is an indication of providing an alternative value said determining comprising:
updating said transaction record with said alternative value;
transmitting said transaction record to said first client terminal;
receiving, a second value from said initiating account; and
determining said final transaction value based on said second selection, said second value being bound by a history of transaction values based on transactions involving said first network.
